(19) United States
(12) Patent Application Publication
(10) Pub. No.: US 2025/0363650 A1
(43) Pub. Date: Nov. 27, 2025

(54) ZERO-SHOT MONOCULAR DEPTH ESTIMATION USING GENERATIVE ARTIFICIAL INTELLIGENCE MODELS

(71) Applicants: DISNEY ENTERPRISES, INC., Burbank, CA (US); ETH Zürich (Eidgenössische Technische Hochschule Zürich), Zürich (CH)

(72) Inventors: Christopher Richard SCHROERS, Uster (CH); Hayko Jochen Wilhelm RIEMENSCHNEIDER, Zürich (CH); Bingxin KE, Zürich (CH); Konrad SCHINDLER, Oberengstringen (CH); Xiang ZHANG, Dietikon (CH)

(21) Appl. No.: 19/210,463

(22) Filed: May 16, 2025

Related U.S. Application Data
(60) Provisional application No. 63/650,321, filed on May 21, 2024.

(51) Int. Cl. G06T 7/50; G06T 7/30

(52) U.S. Cl. CPC G06T 7/50; G06T 7/30; G06T 2207/20081

(57) ABSTRACT

Embodiments of the present disclosure provide techniques for training a generative artificial intelligence model to generate depth estimates for an input image. An example method generally includes generating a coarse depth map from an input image in a training data set. The coarse depth map is aligned based on a ground-truth depth map corresponding to the input image in the training data set. A masked depth map is generated based on distances calculated between different portions of the aligned coarse depth map. A generative artificial intelligence model is trained to perform monocular depth estimation on an image of a scene based on the input image and the masked depth map. The trained generative artificial intelligence model is deployed.

### CROSS-REFERENCE TO RELATED APPLICATIONS

This application claims benefit of and priority to U.S. Provisional Patent titled “Pluggable Diffusion Refinement for Zero-Shot Monocular Depth Estimation,” Application Ser. No. 63/650,321, filed May 21, 2024. The subject matter of this related application is hereby incorporated herein by reference.

### BACKGROUND

### Field of the Various Embodiments

Embodiments of the present disclosure relate generally to computer vision and machine learning and, more specifically, to techniques for depth estimation for monocular images.

### Description of the Related Art

Depth information is used in various tasks, such as autonomous driving, robotics, digital graphics rendering, and the like. Depth information can be obtained various inputs, such as ranging data inputs (e.g., from radar, light detection and ranging (LIDAR) sensors, etc.) or image data. For image data, depth information can be easily obtained from stereo imagery. However, obtaining depth information from monocular images (e.g., single-view images) is complicated task.

To obtain depth information for a scene captured in a monocular image, machine learning models can be trained to use geometric prior information learned from a training data set to generate depth information for an input image. The images in a training data set used to train such a model may be generalized across a variety of scenes included in the training data set. However, because the training data set may lack fine-grained depth data, the depth data associated with images in the training data set may be coarse, noisy, and incomplete. Thus, machine learning models trained to generate estimated depth information for an input image may be generalized and coarse or specific to a particular environment and more detailed.

To address tradeoffs between generalizability and quality of depth estimation outputs generated by a generative artificial intelligence model, iterative refinement schemes can be used to generate a depth estimation output for an input image. These iterative refinement schemes, such as those used by diffusion-based models in which a noise input is progressively denoised until a clean image is recovered, allow for the generation of depth maps or other depth estimates for an input image that is detailed and includes granular and accurate depth information. A generative model used to generate these depth maps or other depth estimates may be trained using detailed depth labels associated with different objects in a scene. Because such data is typically not available in training data sets including real-world data, synthetic data sets may be used. These synthetic data sets, however, may include data from a limited variety of scenes and include a relatively small number of samples. Thus, using synthetic data sets to train a generative model to generate a depth map or depth estimate for an input image may also result in a model that is not generalizable across a variety of scenes or environments for which depth data is to be generated.

Thus, what is needed in the art are more effective techniques for depth estimation for scenes depicted in an input image using artificial intelligence models.

### SUMMARY

One embodiment of the present disclosure sets forth techniques for training a generative artificial intelligence model to generate depth estimates for an input image. An example method generally includes generating a coarse depth map from an input image in a training data set. The coarse depth map is aligned based on a ground-truth depth map corresponding to the input image in the training data set. A masked depth map is generated based on distances calculated between different portions of the aligned coarse depth map. A generative artificial intelligence model is trained to perform monocular depth estimation on an image of a scene based on the input image and the masked depth map. The trained generative artificial intelligence model is deployed.

One embodiment of the present disclosure sets forth techniques for performing depth estimation for an input image using a generative artificial intelligence model. An example method generally includes generating a coarse depth map from an input image. A latent space representation of a fine depth map for the input image is generated based on a generative artificial intelligence model, the input image, the coarse depth map, and a noise input. The fine depth map is decoded from the latent space representation, and the fine depth map is output.

One technical advantage of the disclosed techniques is that the disclosed techniques allow for accurate generation of detailed depth information for an input image using generative models that are generalizable across a variety of environments. The techniques discussed herein may allow for a generative artificial intelligence model to be trained to generate a fine depth map using denoising techniques based on an input of an input image and a coarse depth map generated for the input image. Generally, the generative artificial intelligence model need not be trained to perform depth estimation or to generate a depth map for content in a specific environment; rather, the provision of an input image and a coarse depth map may allow for zero-shot training of the generative model at inferencing time. Further, depth maps generated using the techniques discussed herein may be generated with higher fidelity than depth maps generated using other techniques. This increased accuracy in the depth maps generated using a generative artificial intelligence model may, in turn, allow for finer control of autonomous vehicles, robots, or other devices operating in the physical realm, the generation of detailed depth-based visual effects, and the like.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 illustrates an example pipeline for training a generative artificial intelligence model to generate a detailed depth map for an input image based on denoising techniques and depth map masking, according to some embodiments.

FIG. 3 illustrates an example pipeline for generating a fine depth map for an input image using a generative artificial intelligence model, according to some embodiments.

FIG. 4 illustrates example operations for training a generative artificial intelligence model to generate a depth map for an input image based on denoising techniques and depth map masking, according to some embodiments.

FIG. 5 illustrates example operations for generating a fine depth map for an input image using a generative artificial intelligence model, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

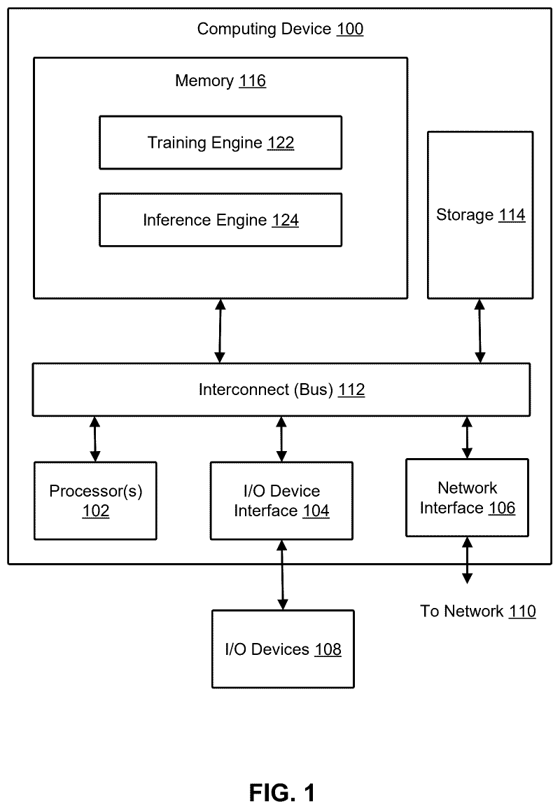

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an inference engine 124 that reside in a memory 116.

It is noted that the computing device described herein is illustrative and that any other technically feasible configurations fall within the scope of the present disclosure. For example, multiple instances of training engine 122 or inference engine 124 could execute on a set of nodes in a distributed and/or cloud computing system to implement the functionality of computing device 100. In another example, training engine 122 or inference engine 124 could execute on various sets of hardware, types of devices, or environments to adapt training engine 122 or inference engine 124 to different use cases or applications. In a third example, training engine 122 or inference engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (Al) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and inference engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 or inference engine 124.

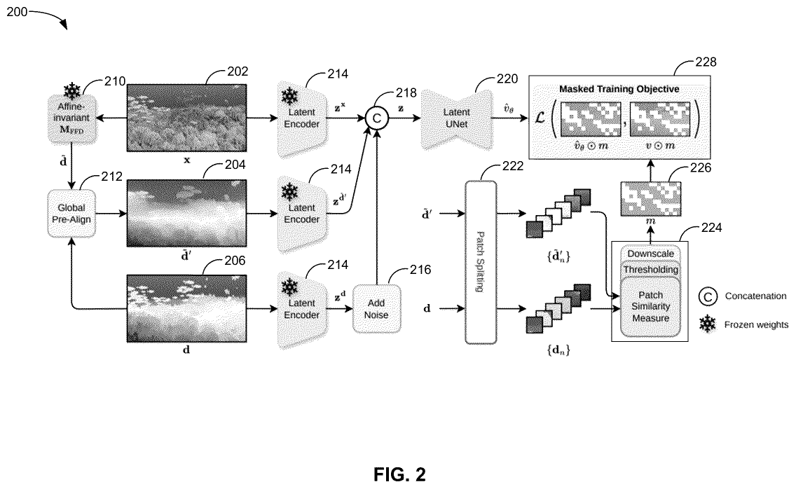

FIG. 2 illustrates a training pipeline 200 for training a generative artificial intelligence model to generate a detailed depth map for an input image based on denoising techniques and depth map masking, according to some embodiments. The training pipeline 200 may execute, for example, on the training engine 122 to train one or more machine learning models to generate a detailed depth map for an input image.

As illustrated, outputs of a pretrained depth estimation network 210 and a pretrained latent encoder 214 are used to generate an input based on which generative artificial intelligence model 220 is trained to generate detailed depth maps. Generally, in training an artificial intelligence model (e.g., generative artificial intelligence model 220) to perform depth estimation and generate estimated depth data (e.g., in the form of a depth map) for an input image, training engine 122 can train the artificial intelligence model based on the training objective

$${ℒ}_{DM} ( ϵ , {M}_{DM} ( {x}_{i} , AddNoise ( {d}_{i} , ϵ , t )$$

where xᵢ represents the i^{th} image in a training data set D, dᵢ represents the depth label data corresponding to xᵢ, and ϵ˜ [symbol] (0, I) represents Gaussian noise (or other noise). [symbol] _{DM} generally represents a loss function for a diffusion model, such as a velocity metric, In learning to perform depth estimation, a generative artificial intelligence model 220 may be trained to iteratively generate a depth map or other depth data in a T-step forward process in which samples are gradually corrupted with random Gaussian noise at each timestamp t∈{1, . . . , T}. The model may then be learned to reverse this process to transform random Gaussian noise into a sample in a target data distribution. In doing so, dᵢ is not directly fit to a sample in the target data distribution; rather, the generative artificial intelligence model is trained to estimate the added Gaussian noise from xᵢ and dᵢ at each timestamp t.

Generative artificial intelligence model 220, as illustrated, is trained to generate a detailed depth map based on an encoding of an input image x 202, a aligned coarse depth map \tilde{d}′ 204, and a ground-truth depth map 206. A pretrained depth estimation network 210 generates a coarse depth map \tilde{d} from the input image x 202. To narrow differences between a coarse depth map \tilde{d} and the ground-truth depth map d 206, the coarse depth map \tilde{d} and the ground-truth depth map d 206 may be processed at global pre-alignment block 212 to generate aligned coarse depth map \tilde{d}′ 204. Because the estimated depth values in \tilde{d} deviate from the ground-truth depth map d 206 due to an unknown scale and shift, using \tilde{d} directly to train generative artificial intelligence model 220 may result in the model learning to overfit to the training data and prevent generative artificial intelligence model 220 from accurately generating depth maps for an input image.

Global pre-alignment block 212 generally aligns the coarse depth map \tilde{d} to the ground-truth depth map d by estimating a scale variable s and a shift variable b and aligns the coarse depth map \tilde{d} to the ground-truth depth map d. The aligned coarse depth map \tilde{d}′ may be represented by the equation:

$${\tilde{d}}^{′} = s \tilde{d} + b$$

In some embodiments, the scale variable s and shift variable b may be estimated based on least squares fitting between the coarse depth map \tilde{d} and the ground-truth depth map d, according to the equation:

$$( s , b ) = arg {min}_{s , b} {‖ s \tilde{d} + b - d ‖}_{2}^{2}$$

Subsequently, x, \tilde{d}′, and d may be encoded into latent space representations z^{x}, [symbol] , and z^{d} of the input image, aligned coarse depth map, and ground-truth depth map, respectively, using encoders 214. To train the generative artificial intelligence model 220, noise, such as Gaussian noise, may be added to the encoding z^{d} of the ground-truth depth map 206 so that the generative artificial intelligence model is trained to recover the ground-truth depth map d 206 given an input of an image and a corresponding coarse depth map. At concatenation block 218, the latent space representation of the input image, z^{x}, the latent space representation of the aligned coarse depth map [symbol] , and the noised latent space representation of the ground-truth depth map z^{d} are provided as input into the generative artificial intelligence model 220.

The training objective 228 for the generative artificial intelligence model 220 may be defined based on a loss between a ground-truth depth map and a generated depth map. To allow the generative artificial intelligence model 220 to generate accurate detailed depth maps, training engine 122 can generate masks that are used to restrict refinement of a coarse depth map into a detailed or fine depth map to regions in \tilde{d}′ and d that are similar while bypassing refinement of regions that are different by more than a threshold amount. Patch splitting block 222 generally partitions the aligned coarse depth map \tilde{d}′ 204 and the ground-truth depth map d 206 into non-overlapping patches

$$\{ {\tilde{d}}_{n}^{′} \}$$

and {dₙ}, respectively.

$${\tilde{d}}_{n}^{′}$$

∈ [symbol] ^{w×w} and dₙ∈ [symbol] ^{w×w}, where w corresponds to a patch size. The patch size may be defined, for example, as a number of pixels.

Mask generator 224 performs patchwise comparison between a patch in

$$\{ {\tilde{d}}_{n}^{′} \}$$

and a corresponding patch in {dₙ} and measures the similarity between the patch from the aligned coarse depth map and the corresponding patch in the ground-truth depth map. The similarity metric may be, for example, a Euclidean distance between the patch from the aligned coarse depth map and the corresponding patch in the ground-truth depth map, defined according to the equation:

$$Dist ( {\tilde{d}}_{n}^{′} , {d}_{n} ) = {‖ {\tilde{d}}_{n}^{′} - {d}_{n} ‖}_{2}$$

Based on the distance between patches in \tilde{d}′ and d, mask generator 224 generates a pixel-space mask M according to the expression:

$${M}_{n} = \{ \begin{matrix}1 , & if Dist ( {\tilde{d}}_{n}^{′} , {d}_{n} ) \leq w \cdot η \\ 0 , & if otherwise\end{matrix}$$

In the expression above, η represents the average tolerance per pixel in the patch. Values of η generally control trade-offs in generative artificial intelligence model 220 between depth conditioning and detail refinement. Mask generator 224 downscales the pixel-space mask M to a latent space mask m 226 via a max pooling layer, and the mask m 226 is used in the training objective 228 to mask off areas in the coarse and ground-truth depth maps that are highly dissimilar and focus the training on areas in the coarse depth map that can be refined using the ground-truth depth map. The training objective may be, for example, a velocity prediction objective in which a velocity metric v is used to drive the denoising of a noisy latent to a depth map or other depth data sampled from a target distribution. In some embodiments, the loss objective 228 may be defined according to the equation:

$$ℒ = {𝔼}_{z , ϵ ∼ 𝒩 ( 0 , I ) , t ∼ 𝒰 ( T )} [ \frac{1}{γ} {‖ {\hat{v}}_{θ} ( z , t ) ⊙ m - v ( {z}_{0}^{d} , ϵ , t ) ⊙ m ‖}_{2}^{2} ]$$

In the above equation, γ represents the number of valid elements in the downscaled mask m 226, \hat{v}_{θ} represents the velocity estimated from the generative artificial intelligence model with

$$z = Cat ( {z}^{x} , {z}^{{\overline{d}}^{′}} , {z}_{t}^{d} ) , and v ( {z}_{0}^{d} , ϵ , t )$$

represents a ground-truth velocity. The ground truth velocity

$$v ( {z}_{0}^{d} , ϵ , t )$$

may be defined according to the equation:

$$v ( {z}_{0}^{d} , ϵ , t ) = \sqrt{{\overline{α}}_{t}} ϵ - \sqrt{1 - {\overline{α}}_{t}} {z}_{0}^{d}$$

After training the generative artificial intelligence model 220, training engine 122 deploys the trained generative artificial intelligence model 220 for use. In some embodiments, the generative artificial intelligence model 220 may be deployed to a remote system on which inferencing tasks are to be performed, such as an autonomous vehicle, a robot, or the like. In some embodiments, training engine 122 and inferencing engine 124 may be collocated, and generative artificial intelligence model 220 may be deployed from training engine 122 to inferencing engine 124.

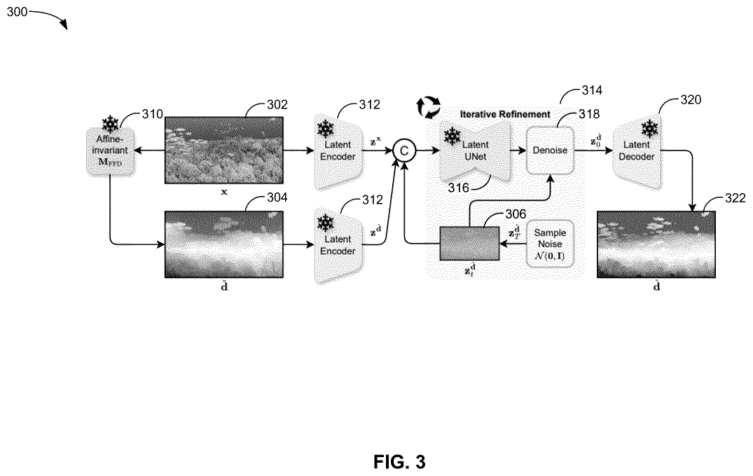

FIG. 3 illustrates an example pipeline 300 for generating a fine depth map for an input image using a generative artificial intelligence model, according to some embodiments.

In pipeline 300, an input image 302 is received for processing. To provide sufficient information for the generative artificial intelligence model to be conditioned for the specific scenario illustrated in the input image x 302, a pretrained depth estimation network 310 generates a depth map \tilde{d} 304 based on the input image 302. The input image x 302 and depth map \tilde{d} 304 are converted into latent space embeddings z^{x} and [symbol] by an encoder 312. Inferencing engine 124 can concatenate the latent space embeddings z^{x} and [symbol] with a noise distribution 306 sampled from a Gaussian noise distribution as an initial input into generative artificial intelligence model 314.

Generative artificial intelligence model 314 generally includes a noise prediction model 316 and a denoisier 318 that removes the predicted noise from the noise distribution or other noisy input 306. Generally, multiple inferencing iterations using generative artificial intelligence model 314 may be performed to iteratively recover a detailed depth map for the input image x 302. The noise sampled from a Gaussian noise distribution (or a latent space representation of the noise sampled from the Gaussian noise distribution) may be iteratively denoised during each inferencing round performed using generative artificial intelligence model 314 to recover a latent space representation

$${z}_{0}^{\hat{d}}$$

of a fine depth map corresponding to the input image x 302. A decoder 320 receives as input the latent space representation and decodes the fine depth map \hat{d} 322 from the latent space representation.

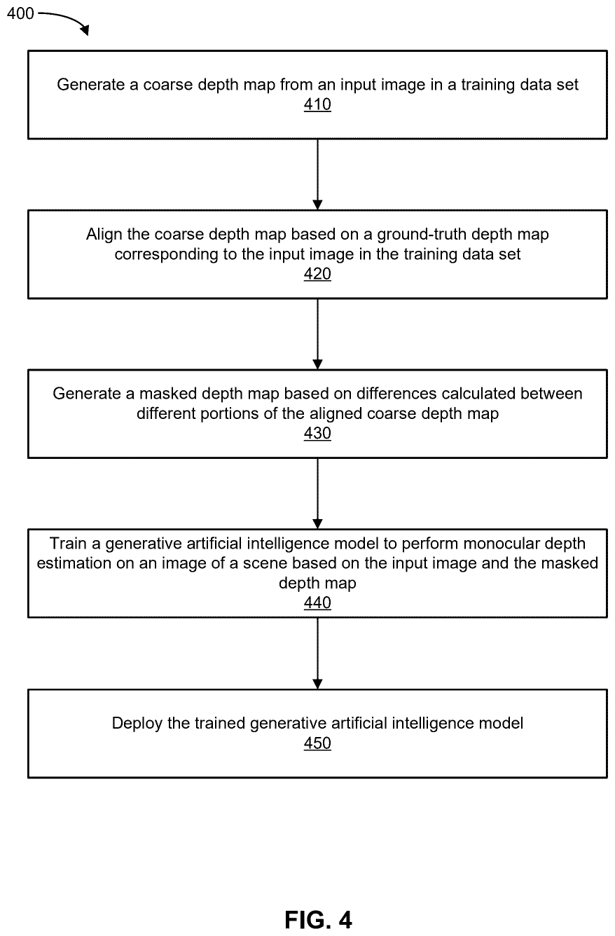

FIG. 4 is a flow diagram illustrating operations 400 for training a generative artificial intelligence model to generate a depth map for an input image based on denoising techniques and depth map masking, according to some embodiments. The operations 400 may be performed, for example, by a computing device including one or more processors on which a training engine 122 illustrated in FIG. 1 can execute, such as a desktop computer, a server, a cluster of computing devices, one or more cloud compute instances, or the like.

As illustrated, operations 400 begin at block 410, where training engine 122 generates a coarse depth map from an input image in a training data set. Generally, training engine 122 can generate the coarse depth map for the input image by processing the input image through a pretrained depth estimation network. The input image may be, for example, a monocular image, or an image captured from a single camera from a single vantage point.

At block 420, operations 400 proceed with training engine 122 aligning the coarse depth map based on a ground-truth depth map corresponding to the input image in the training data set.

In some embodiments, training engine 122 aligns the coarse depth map to the ground-truth depth may by estimating one or more transformations to apply to the coarse depth map and aligning the coarse depth map by applying the one or more transformations. The one or more transformations may include, for example, one or more of a scaling factor or a shifting factor applied to the coarse depth map. In some embodiments, training engine 122 estimates the one or more transformations to apply to the coarse depth map based on least squares fitting of depth data in the coarse depth map to corresponding depth data in the ground-truth depth map.

At block 430, operations 400 proceed with training engine 122 generating a masked depth map based on distances calculated between different portions of the aligned coarse depth map.

In some embodiments, training engine 122 generates the masked depth map by partitioning the aligned depth map and the ground-truth depth map into a plurality of non-overlapping patches. Training engine 122 can generate a mask based on a difference between a depth associated with a patch in the aligned depth map and a depth associated with a corresponding patch in the ground-truth depth map.

In some embodiments, to generate the mask, training engine performs a patchwise analysis of the difference between depths associated with a patch in the aligned coarse depth map and depths associated with corresponding patches in the ground-truth depth map. When a difference between depths for a patch in the aligned depth map and a corresponding patch in the ground-truth depth map exceeds a defined difference, training engine 122 can mask the patch in the aligned coarse depth map. Generally, patches in the aligned depth map may have a size that equals the size of the corresponding patch in the ground-truth depth map.

At block 440, operations 400 proceed with training engine 122 training a generative artificial intelligence model to perform monocular depth estimation on an image of a scene based on the input image and the masked depth map.

In some embodiments, training engine 122 trains the generative artificial intelligence model based on projecting the input image, the aligned depth map, and the ground-truth depth map into a latent space. The projection of the input image, the aligned coarse depth map, and the ground-truth depth map into a latent space may be performed, for example, by generating an encoding, using a pretrained encoder, of the input image, the aligned coarse depth map, and the ground-truth depth map. Training engine 122 can add noise to the latent space representation of the ground-truth depth map and concatenate the latent space representations of the input image and the aligned coarse depth map and the noised latent space representation of the ground-truth depth map and input the concatenated latent space representation into the generative model for training. The generative artificial intelligence model may be trained to recover an approximation of the ground-truth depth map based on denoising the noised latent space representation of the ground-truth depth map. The recovery of the ground-truth depth map may be conditioned on the input image and the masked depth map

In some embodiments, training engine 122 trains the generative artificial intelligence model based on a training objective that is masked based on calculated differences between depths associated with patches in the aligned coarse depth map and corresponding patches in the ground-truth depth map. Generally, the mask applied to the predicted and ground-truth depth maps used to calculate a loss between the predicted and ground-truth depth maps may restrict training to patches in the aligned coarse depth map and the ground-truth depth map that are sufficiently close to each other in depth (e.g., have a distance less than a threshold distance). By doing so, as discussed, the generative artificial intelligence model may be trained to be effectively conditioned on depth data in local regions while allowing for detail refinement during the iterative denoising process.

At block 450, operations 400 proceed with training engine 122 deploying the trained generative artificial intelligence model.

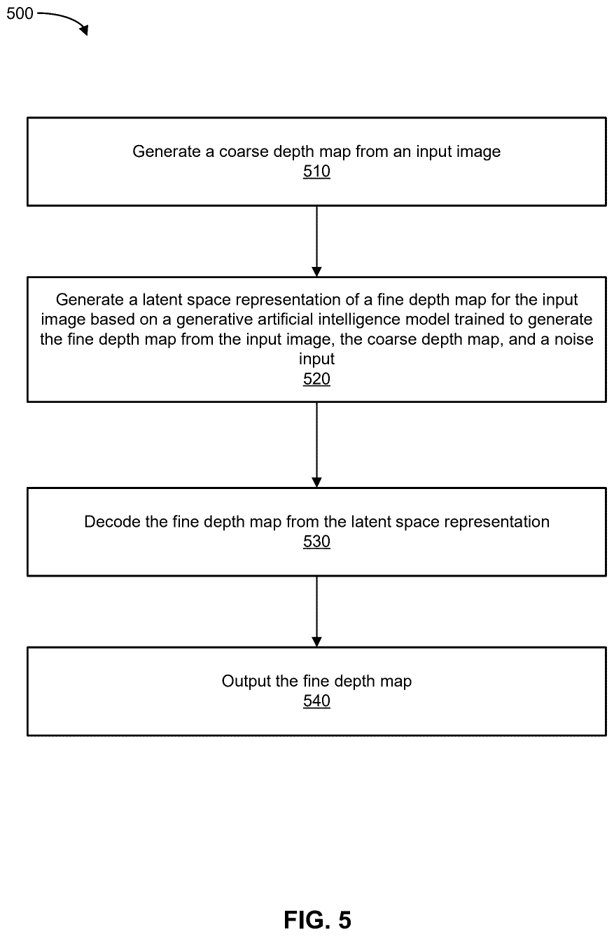

FIG. 5 is a flow diagram illustrating operations 500 for generating a fine depth map for an input image using a generative artificial intelligence model, according to some embodiments. The operations 500 may be performed, for example, by a computing device including one or more processors on which an inferencing engine 124 illustrated in FIG. 1 can execute, such as a desktop computer, a server, a cluster of computing devices, one or more cloud compute instances, or the like.

As illustrated, operations 500 begin at block 510, where inferencing engine 124 generates a coarse depth map from an input image. In some embodiments, inferencing engine 124 can generate the coarse depth map using a pre-trained affine-invariant depth model. In some embodiments, the input image may be a monocular image.

At block 520, operations 500 proceed with inferencing engine 124 generating a latent space representation of a fine depth map for the input image based on a generative artificial intelligence model, the input image, the coarse depth map, and a noise input.

In some embodiments, inferencing engine 124 can generate the latent space representation of the fine depth map for the input image by generating a concatenated encoding of the input image, the coarse depth map, and the noise input. Inferencing engine 124 iteratively denoises the noise input based on the generative artificial intelligence model and the concatenated encoding of the input image, the coarse depth map, and the noise input. As discussed, the input image and the coarse depth map may serve as conditioning data for the generative artificial intelligence model to use to learn details of the environment depicted in the input image using zero-shot learning techniques.

In some embodiments, the generative artificial intelligence model comprises a model trained to generate the fine depth map using zero-shot generalizability based on the coarse depth map and detail conditioning based on the input image.

In some embodiments, in an initial inferencing round performed using the generative artificial intelligence model, the noise input may be a noise sample selected from a Gaussian noise distribution.

At block 530, operations 500 proceed with inferencing engine 124 decoding the fine depth map from the latent space representation.

At block 540, operations 500 proceed with inferencing engine 124 outputting the fine depth map. The fine depth map may serve as an input to one or more downstream processes that uses depth information to determine an action to be applied in a variety of scenarios. For example, the fine depth map may be used in an autonomous driving application to determine the proximity of an autonomous vehicle to various obstacles in the path in which the autonomous vehicle is driving. Based on the proximity of the vehicle to obstacles, the vehicle can perform various driving actions (e.g., steering, acceleration, braking, etc.) to avoid collisions between the vehicle and these obstacles. Similarly, the fine depth map may be used in a robotics application to determine the proximity of a robotic manipulator to various objects in the environment in which the robot operates. This proximity information can be used, for example, to determine how the robot is to move in order to perform a given task. In yet another example, the fine depth map may be used in graphics rendering software applications to apply various depth-based effects to extant visual footage. It should be recognized, however, that the foregoing are but examples of operations that can be performed using the fine depth map generated in operations 500, and other operations in the same or different execution environment may be contemplated.

The techniques discussed herein generally allow generative artificial intelligence models to efficiently be trained to generate accurate depth maps for an input of a monocular image. A generative artificial intelligence model trained using the techniques described herein may be trained using significantly fewer training iterations than other generative models that are trained to generate depth information from an input image. For example, embodiments described herein may allow for a generative artificial intelligence model trained using 200 iterations to exhibit comparable inferencing performance to a model trained using 5,000 iterations in prior approaches, representing a significant decrease in computational resource utilization during the training process (e.g., the use of significantly fewer processing cycles and memory, as well as significantly less power). In inferencing, the generative artificial intelligence model may generate results with higher fidelity using fewer computing resources than used by prior approaches to generate fine, detailed depth maps for an input image. These technical advantages provide one or more improvements over prior approaches.

### Example Clauses

Various embodiments of the present disclosure are described in the following numbered clauses:

1. In some embodiments, a computer-implemented method for training a generative artificial intelligence model to generate a depth map for an input image, the computer-implemented method comprises generating a coarse depth map from an input image in a training data set; aligning the coarse depth map based on a ground-truth depth map corresponding to the input image in the training data set; generating a masked depth map based on distances calculated between different portions of the aligned coarse depth map; training a generative artificial intelligence model to perform monocular depth estimation on an image of a scene based on the input image and the masked depth map; and deploying the trained generative artificial intelligence model.

2. The method of clause 1, wherein aligning the coarse depth map comprises: estimating one or more transformations to apply to the coarse depth map; and aligning the coarse depth map to the ground-truth depth map based on the one or more transformations.

3. The method of clause 2, wherein the one or more transformations comprise one or more of a scaling factor or a shifting factor applied to the coarse depth map.

4. The method of any of clauses 2 or 3, wherein the one or more transformations to apply to the coarse depth map are estimated based on least squares fitting of depth data in the coarse depth map to corresponding depth data in the ground-truth depth map.

5. The method of any of clauses 1 through 4, wherein generating the masked depth map comprises: partitioning the aligned depth map and the ground-truth depth map into a plurality of non-overlapping patches; and generating a mask based on a difference between a depth associated with a patch in the aligned depth map and a depth associated with a corresponding patch in the ground-truth depth map.

6. The method of clause 5, wherein generating the mask comprises: determining that the difference between the depth associated with a patch in the aligned depth map and the depth associated with a corresponding patch in the ground-truth depth map exceeds a threshold difference; and masking the patch in the aligned coarse depth map based on the determining.

7. The method of any of clauses 5 or 6, wherein a size of the patch in the aligned depth map equals a size of the corresponding patch in the ground-truth depth map.

8. The method of any of clauses 1 through 7, wherein training the generative artificial intelligence model comprises: projecting the input image, the aligned coarse depth map, and the ground-truth depth map into a latent space; noising a latent space representation of the ground-truth depth map; and training the generative artificial intelligence model to recover an approximation of the ground-truth depth map based on denoising the noised latent space representation of the ground-truth depth map, the denoising being conditioned on the input image and the masked depth map.

9. The method of any of clauses 1 through 8, wherein the input image comprises a monocular image.

10. In some embodiments, a processor-implemented method for generating a depth map for an input image using a generative artificial intelligence model, the computer-implemented method comprises generating a coarse depth map from an input image; generating a latent space representation of a fine depth map for the input image based on a generative artificial intelligence model, the input image, the coarse depth map, and a noise input; decoding the fine depth map from the latent space representation; and outputting the fine depth map.

11. The method of clause 10, wherein generating the latent space representation of the fine depth map for the input image comprises: generating a concatenated encoding of the input image, the coarse depth map, and the noise input; and iteratively denoising the noise input based on the generative artificial intelligence model and the concatenated encoding of the input image, the coarse depth map, and the noise input.

12. The method of any of clauses 10 or 11, wherein the coarse depth map is generated using a pre-trained affine-invariant depth model.

13. The method of any of clauses 10 through 12, wherein the generative artificial intelligence model comprises a model trained to generate the fine depth map using zero-shot generalizability based on the coarse depth map and detail conditioning based on the input image.

14. The method of any of clauses 10 through 13, wherein the noise input comprises a noise sample selected from a Gaussian noise distribution.

15. The method of any of clauses 10 through 14, wherein the input image comprises a monocular image.

16. A processing system, comprising: at least one memory having executable instructions thereon; and one or more processors configured to execute the executable instructions to cause the processing system to perform the method of any of clauses 1 through 15.

17. A processing system, comprising means for performing the method of any of clauses 1 through 15.

18. A non-transitory computer-readable medium having executable instructions stored thereon which, when processed by one or more processors, causes the one or more processors to perform the method of any of clauses 1 through 15.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A processor-implemented method, comprising:
generating a coarse depth map from an input image in a training data set;
aligning the coarse depth map based on a ground-truth depth map corresponding to the input image in the training data set;
generating a masked depth map based on distances calculated between different portions of the aligned coarse depth map;
training a generative artificial intelligence model to perform monocular depth estimation on an image of a scene based on the input image and the masked depth map; and
deploying the trained generative artificial intelligence model.

2. The method of claim 1, wherein aligning the coarse depth map comprises:
estimating one or more transformations to apply to the coarse depth map; and
aligning the coarse depth map to the ground-truth depth map based on the one or more transformations.

3. The method of claim 2, wherein the one or more transformations comprise one or more of a scaling factor or a shifting factor applied to the coarse depth map.

4. The method of claim 2, wherein the one or more transformations to apply to the coarse depth map are estimated based on least squares fitting of depth data in the coarse depth map to corresponding depth data in the ground-truth depth map.

5. The method of claim 1, wherein generating the masked depth map comprises:
partitioning the aligned depth map and the ground-truth depth map into a plurality of non-overlapping patches; and
generating a mask based on a difference between a depth associated with a patch in the aligned depth map and a depth associated with a corresponding patch in the ground-truth depth map.

6. The method of claim 5, wherein generating the mask comprises:
determining that the difference between the depth associated with a patch in the aligned depth map and the depth associated with a corresponding patch in the ground-truth depth map exceeds a threshold difference; and
masking the patch in the aligned coarse depth map based on the determining.

7. The method of claim 5, wherein a size of the patch in the aligned depth map equals a size of the corresponding patch in the ground-truth depth map.

8. The method of claim 1, wherein training the generative artificial intelligence model comprises:
projecting the input image, the aligned coarse depth map, and the ground-truth depth map into a latent space;
noising a latent space representation of the ground-truth depth map; and
training the generative artificial intelligence model to recover an approximation of the ground-truth depth map based on denoising the noised latent space representation of the ground-truth depth map, the denoising being conditioned on the input image and the masked depth map.

9. The method of claim 1, wherein the input image comprises a monocular image.

10. A processor-implemented method, comprising:
generating a coarse depth map from an input image;
generating a latent space representation of a fine depth map for the input image based on a generative artificial intelligence model, the input image, the coarse depth map, and a noise input;
decoding the fine depth map from the latent space representation; and
outputting the fine depth map.

11. The method of claim 10, wherein generating the latent space representation of the fine depth map for the input image comprises:
generating a concatenated encoding of the input image, the coarse depth map, and the noise input; and
iteratively denoising the noise input based on the generative artificial intelligence model and the concatenated encoding of the input image, the coarse depth map, and the noise input.

12. The method of claim 10, wherein the coarse depth map is generated using a pre-trained affine-invariant depth model.

13. The method of claim 10, wherein the generative artificial intelligence model comprises a model trained to generate the fine depth map using zero-shot generalizability based on the coarse depth map and detail conditioning based on the input image.

14. The method of claim 10, wherein the noise input comprises a noise sample selected from a Gaussian noise distribution.

15. The method of claim 10, wherein the input image comprises a monocular image.

16. A processing system, comprising:
at least one memory having executable instructions stored thereon; and
one or more processors configured to execute the executable instructions to cause the processing system to:
generate a coarse depth map from an input image in a training data set;
align the coarse depth map based on a ground-truth depth map corresponding to the input image in the training data set;
generate a masked depth map based on distances calculated between different portions of the aligned coarse depth map;
train a generative artificial intelligence model to perform monocular depth estimation on an image of a scene based on the input image and the masked depth map; and
deploy the trained generative artificial intelligence model.

17. The processing system of claim 16, wherein to align the coarse depth map, the one or more processors are configured to cause the processing system to:
estimate one or more transformations to apply to the coarse depth map; and
align the coarse depth map to the ground-truth depth map based on the one or more transformations.

18. The processing system of claim 16, wherein to generate the masked depth map, the one or more processors are configured to cause the processing system to:
partition the aligned depth map and the ground-truth depth map into a plurality of non-overlapping patches; and
generate a mask based on a difference between a depth associated with a patch in the aligned depth map and a depth associated with a corresponding patch in the ground-truth depth map.

19. The processing system of claim 18, wherein to generate the mask, the one or more processors are configured to cause the processing system to:
determine that the difference between the depth associated with a patch in the aligned depth map and the depth associated with a corresponding patch in the ground-truth depth map exceeds a threshold difference; and
mask the patch in the aligned coarse depth map based on the determination.

20. The processing system of claim 16, wherein to train the generative artificial intelligence model, the one or more processors are configured to cause the processing system to:
project the input image, the aligned coarse depth map, and the ground-truth depth map into a latent space;
noise a latent space representation of the ground-truth depth map; and
train the generative artificial intelligence model to recover an approximation of the ground-truth depth map based on denoising the noised latent space representation of the ground-truth depth map, the denoising being conditioned on the input image and the masked depth map.
